(19) United States
(12) Patent Application Publication
(10) Pub. No.: US 2026/0278461 A1
(43) Pub. Date: Sep. 17, 2026

(54) METHOD AND SYSTEM FOR DYNAMICALLY CUSTOMIZING FOOD FORMULATIONS

(71) Applicant: Sustento Inc., Toronto (CA)

(72) Inventors: Sofia Bonilla, Mississauga (CA); Alexandra Camara, Paris (CA)

(73) Assignee: Sustento Inc., Toronto (CA)

(21) Appl. No.: 19/463,658

(22) Filed: Jan. 29, 2026

(30) Foreign Application Priority Data
Mar. 6, 2025 (CA) 3266905

(51) Int. Cl. G06N 20/00

(52) U.S. Cl. CPC G06N 20/00

(57) ABSTRACT

The present disclosure provides a system, a method and a non-transitory computer-readable storage medium for dynamically customizing one or more pre-existing food formulations. The method includes receiving one or more input parameters from a user device. The method includes extracting one or more pre-existing food formulations and a set of food processing conditions for the one or more pre-existing food formulations. The method includes generating, using the machine learning model, the nutrient degradation profile for each nutrient corresponding to one or more ingredients associated with the one or more pre-existing food formulations. The method includes determining a set of degradation coefficients for each nutrient corresponding to the one or more ingredients. The method includes predicting nutrient retention rates associated with the one or more pre-existing food formulations. The method includes customizing the one or more pre-existing food formulations.

### CROSS-REFERENCE TO RELATED APPLICATIONS

The present application claims the benefit of Canadian Patent Application No. 3266905, filed on Mar. 6, 2025, all of which are hereby incorporated by reference in their entirety for all purposes.

### TECHNICAL FIELD

The present disclosure relates to the field of machine learning, and in particular, relates to method and system for dynamically customizing food formulations using a machine learning model.

### BACKGROUND

The pet and animal food industry has seen significant advancements in recent years, driven by growing consumer demand for high-quality, nutritionally optimized, and environmentally sustainable products. Modern pet owners increasingly seek solutions that address specific dietary and health needs while ensuring transparency, functionality, and compliance with established standards. This shift has prompted the pet and animal food industry to focus on developing food formulations that balance nutrition, palatability, sustainability, and cost-effectiveness. However, the existing food formulation techniques often rely on manual methods or limited datasets, which can lead to inefficiencies, higher costs, and suboptimal product outcomes. The existing food formulation techniques fail to address the complex interdependencies among nutrition, processing impacts, regulatory compliance, sustainability, and cost.

To overcome the above-mentioned limitations, there is a need for an advanced solution for dynamically customizing food formulations using a machine learning model.

### SUMMARY

In an aspect, a method for dynamically customizing food formulations is disclosed. The method includes receiving one or more input parameters from a user device. The method includes extracting one or more pre-existing food formulations and a set of food processing conditions for the one or more pre-existing food formulations from the one or more sources based on the one or more input parameters. In addition, the method includes generating, using the machine learning model, the nutrient degradation profile for each nutrient corresponding to one or more ingredients associated with the one or more pre-existing food formulations. Further, the method includes determining, using the machine learning model, a set of degradation coefficients for each nutrient corresponding to the one or more ingredients associated with the one or more pre-existing food formulations, based on the generated nutrient degradation profile. Also, the method includes predicting, using the machine learning model, nutrient retention rates associated with the one or more pre-existing food formulations, based on at least the nutrient degradation profile, the set of food processing conditions, and historical nutrient retention data. The method includes customizing, using the machine learning model, the one or more pre-existing food formulations based on the predicted nutrient retention rates to generate a customized food formulation.

In an embodiment of the present disclosure, the method includes verifying, using the machine learning model, the customized food formulation based on one or more regulatory guidelines.

In an embodiment of the present disclosure, the one or more input parameters include: pet category, animal category, geographical location, ingredient data, cost-related data, and environmental sustainability parameters.

In an embodiment of the present disclosure, the nutrient degradation profile is generated based on at least historical food processing data associated with the set of food processing conditions of the one or more pre-existing food formulations and scientific studies.

In an embodiment of the present disclosure, the machine learning model comprises at least one of one or more regression models, and neural networks.

In an embodiment of the present disclosure, customizing the one or more pre-existing food formulations includes at least one: adjusting ingredient proportion of the one or more ingredients in the one or more pre-existing food formulations, and modifying a food processing condition associated with the one or more pre-existing food formulations.

In another aspect, a system for dynamically customizing food formulations is disclosed. The system includes one or more processors and a memory storing instructions that, when executed, cause the one or more processors (herein after processor) to be operable to receive the one or more input parameters from a user device. The processor is configured to extract one or more pre-existing food formulations and a set of food processing conditions for the one or more pre-existing food formulations from the one or more sources based on the one or more input parameters. In addition, the processor is configured to generate, using the machine learning model, the nutrient degradation profile for each nutrient corresponding to one or more ingredients associated with the one or more pre-existing food formulations. Further, the processor is configured to determine, using the machine learning model, a set of degradation coefficients for each nutrient corresponding to the one or more ingredients associated with the one or more pre-existing food formulations, based on the generated nutrient degradation profile. Also, the processor is configured to predict, using the machine learning model, nutrient retention rates associated with the one or more pre-existing food formulations, based on at least the nutrient degradation profile, the set of food processing conditions, and historical nutrient retention data. The processor is configured to customize, using the machine learning model, the one or more pre-existing food formulations based on the predicted nutrient retention rates to generate a customized food formulation.

In yet another aspect, a non-transitory computer-readable medium storing one or more instructions for generating the food formulations is disclosed. The one or more instructions which, when executed by one or more processors (hereinafter, processor), causes the processor to receive the one or more input parameters from a user device. The one or more instructions which, when executed, causes the processor to extract one or more pre-existing food formulations and a set of food processing conditions for the one or more pre-existing food formulations from the one or more sources based on the one or more input parameters. In addition, the one or more instructions which, when executed, causes the processor to generate, using the machine learning model, the nutrient degradation profile for each nutrient corresponding to one or more ingredients associated with the one or more pre-existing food formulations. Further, the one or more instructions which, when executed, causes the processor to determine, using the machine learning model, a set of degradation coefficients for each nutrient corresponding to the one or more ingredients associated with the one or more pre-existing food formulations, based on the generated nutrient degradation profile. Also, the one or more instructions which, when executed, causes the processor to predict, using the machine learning model, nutrient retention rates associated with the one or more pre-existing food formulations, based on at least the nutrient degradation profile, the set of food processing conditions, and historical nutrient retention data. The one or more instructions which, when executed, causes the processor to customize, using the machine learning model, the one or more pre-existing food formulations based on the predicted nutrient retention rates to generate a customized food formulation.

### BRIEF DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 illustrates an interactive computing environment for dynamically customizing one or more pre-existing food formulations, in accordance with various embodiments of the present disclosure;

FIG. 2 illustrates an exemplary overview of a system for dynamically customizing the one or more pre-existing food formulations, in accordance with various embodiments of the present disclosure;

FIG. 3 illustrates a flow chart of a method for dynamically customizing the one or more pre-existing food formulations, in accordance with various embodiments of the present disclosure; and

FIG. 4 illustrates a block diagram of a computing device, in accordance with various embodiments of the present disclosure.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote features throughout the specification and figures.

### DETAILED DESCRIPTION

In the following description of the disclosure and embodiments, reference is made to the accompanying drawings in which it is shown by way of illustration of specific embodiments that can be practiced. It is to be understood that other embodiments and examples can be practiced, and changes can be made without departing from the scope of the disclosure.

Although the following description uses the terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input can both be outputs and, in some cases, can be separate and different inputs.

The terminology used in the description of the various described examples herein is for the purpose of describing specific examples only and is not intended to be limiting. As used in the description of the various described examples and the appended claims, the singular forms “a,” “an,” and “the” are intended to include the plural forms as well, unless the context clearly indicates otherwise. It will be understood that the term “and/or” as used herein refers to and encompasses any and all possible combinations of one or more of the associated listed items. It will be understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

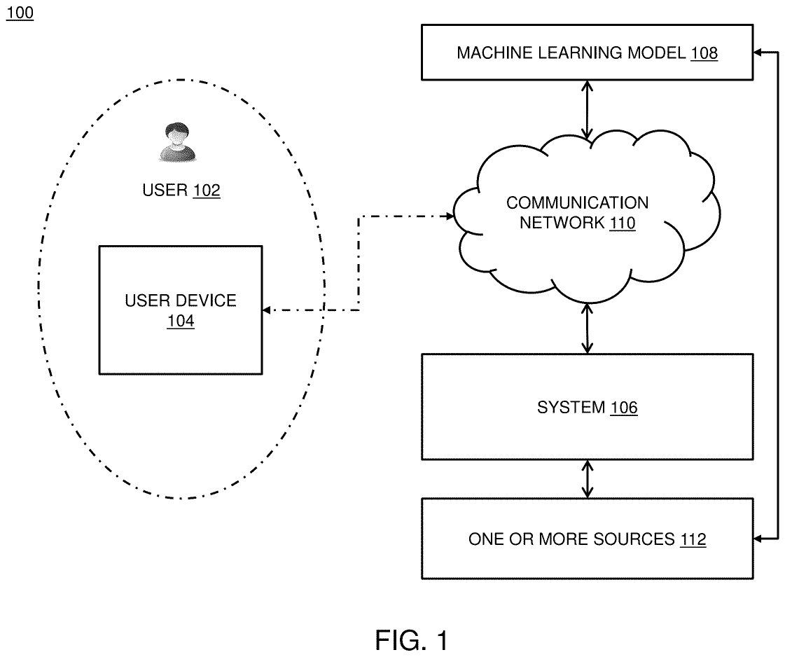

FIG. 1 illustrates an interactive computing environment 100 dynamically customizing one or more pre-existing food formulations, in accordance with various embodiments of the present disclosure. The interactive computing environment 100 includes a user 102, a user device 104 associated with the user 102, a system 106, a machine learning model 108 and one or more data sources 112 associated with the system 106, connected to, and in communication with (and/or with access to) a communication network (e.g., a communication network 110). The components of the interactive computing environment 100 are associated with each other and function properly to perform the machine learning-based customization of the one or more pre-existing food formulations.

The user 102 represents an entity engaging with the system 106 to customize the one or more pre-existing food formulations. In an example, the user 102 may be a food manufacturer seeking customized food formulations. In another example, the user 102 may be a veterinarian or pet/animal nutritionist designing specialized food formulations for pets/animals with medical conditions. In yet another example, the user 102 may be an individual pet owner customizing the one or more pre-existing food formulations tailored to a pet's specific needs. The user 102 provides one or more input parameters to the system 106.

The one or more input parameters includes but may not limited to pet category, food habits, animal category, intended nutritional goals, geographical location of the pet/animal, ingredient preferences, ingredient exclusions, and a set of food processing conditions. Pet category or animal category refers to classification of pets or animals based on their species, age, size, breed, or specific life stage. The pet category or the animal category helps in determining appropriate nutritional requirements for customizing the one or more pre-existing food formulations. In an example, pet category may include species-based classification such as dogs, cats, rabbits, birds and the like. In an example, the animal category may include species-based classifications such as poultry (e.g., chickens, ducks, turkeys), and livestock (e.g., cattle, sheep, goats, pigs).

In another example, pet category may include age-based classification such as puppies/kittens (growth stage), adult pets (maintenance stage), senior pets (aging stage). In yet another example, pet category may include size-based classification such as small breeds (e.g. Chihuahuas, Persian cats, etc.). In yet another example, pet category includes specialized category based on health conditions such as overweight or obese pets, pets with food allergies, pet with kidney disease, etc. Further, pet or animal food habits refer to feeding behaviors, dietary preferences, and consumption patterns of pets.

Also, the geographical location of the pet or animal is utilized to determine its dietary requirements, and ingredient availability for generation of the food formulation. The geographical location of the pet or animal influences selection of ingredients, nutrient composition, and feeding strategies to ensure the pet's or animal's health and well-being in different environmental conditions. The user 102 provides this as an input parameter to the system 106, for customizing the one or more pre-existing food formulations tailored to location-specific needs. For example, pets or animals in colder climates (e.g. Canada, Russia, etc.) require high-calorie diets to maintain body heat. In addition, pets or animals in hot and humid regions (e.g. Deserts, etc.) need hydration focused diets with moisture-rich foods such as wet foods, or hydrating supplements.

Generally, food processing conditions (in context of pet and animal food) refers to methods used to manufacture pet or animal food, each of which affects final product's nutritional composition texture, palatability, and shelf stability. In an embodiment of the present disclosure, the set of food processing conditions may be dry extrusion, baked food, wet canned food, dehydrated food, and the like. For dry extrusion, high-temperature and high-pressure cooking of ingredients are required, followed by shaping and drying. For baked food, ingredients are mixed into a dough, baked at lower temperatures than extrusion, and then cooled. For wet canned foods, ingredients are mixed, cooked, sealed in cans, and sterilized through retort cooking. In addition, for dehydrated food slow removal of moisture is done at low temperatures while preserving nutrients. Each food processing condition of the set of food processing conditions influence the food formulations, necessitating specific adjustments in ingredient selection, nutrient fortification, and compliance checks to maintain nutritional integrity.

In an embodiment of the present disclosure, the food formulations include at least a pet food formulation and an animal feed. The animal feed refers to food formulated for livestock, poultry, and farm animals to support growth, reproduction, and productivity (e.g., milk production, egg-laying, meat yield).

The pet food formulations refer to a structured combination of ingredients tailored to meet specific nutritional, cost, and regulatory requirements. The formulation process balances one or more competing objectives. The one or more competing objectives include at least nutritional adequacy, cost efficiency, palatability and sustainability. The nutritional adequacy ensures essential vitamins, minerals, proteins, and fats that meet pet or animal dietary needs. The cost efficiency corresponds to optimizing ingredient selection to minimize production costs while maintaining quality. The palatability corresponds to enhancement of texture, aroma, and flavour to increase pet or animal acceptance. The sustainability corresponds to evaluating the environmental footprint of ingredients (e.g., greenhouse gas emissions, water consumption, etc.).

The one or more pre-existing food formulations refers to established or previously generated recipes, ingredient compositions, and food processing conditions used to manufacture pet or animal food products. The one or more pre-existing food formulations are extracted from one or more sources 112. The one of more sources 112 include at least one of regulatory databases, historical datasets, ingredient databases, cost datasets, environmental impact datasets, and behaviour studies. Further, the system 106 interacts with the one or more sources 112 to extract the one or more pre-existing food formulations and the set of food processing conditions for the one or more pre-existing food formulations. In addition, the one or more sources are utilized to extract a set of data associated with the one or more food formulations from the one or more sources. The set of data includes but may not be limited to historical nutritional profiles, environmental impact metrics, cost related data, and palatability metrics, historical nutrient retention data.

The user 102 utilizes the user device 104, which serves as an interface for submitting food formulation customization requests and receiving a customized food formulation as output. In an example, the user device 104 includes a smartphone, tablet, personal computer, laptop, or an IoT-enabled food dispenser that automates feeding schedules based on optimized formulations. The user device 104 may include other communication devices equipped with input/output components such as keyboards, touchscreens, and microphones, enabling comprehensive data exchange between the user device 104 and the system 106.

In an embodiment, the user device 104 is a fixed communication device. In another embodiment, the user device 104 is a portable communication device. In some examples, the fixed communication device includes, but is not limited to, desktop computers, smart kiosks, or wall-mounted terminals. In some examples, the portable communication device includes, but is not limited to, smartphones, tablets, laptops, handheld gaming devices, or wearable devices such as smart watches and augmented reality glasses.

The user device 104 runs on an operating system such as iOS, Android, or Windows, providing the necessary software components for data processing and system management. The operating system facilitates communication between hardware and software components, ensuring smooth interaction between the user device 104 and the system 106.

In one implementation, the user device 104 may run on an operating system stored in a memory of the user device 104. In some examples, the operating system may include Darwin, RTXC, LINUX, UNIX, OS X, iOS, WINDOWS, an embedded operating system, and the like. In addition, the user device 104 may run on any version of the operating system. In general, the operating system includes various software components and/or drivers for controlling and managing general system tasks (e.g., memory management, storage device control, power management, etc.) and facilitates communication between various hardware and software components.

The system 106 serves as a central processing unit for executing food formulation customization requests. In particular, the system 106 is configured to customize the one or more pre-existing food formulations. The system 106 is implemented as a cloud-based infrastructure, a distributed server network, or a standalone on-premise computing cluster.

The primary functions of the system 106 include receiving the one or more input parameters from the user device 104 and extracting the one or more pre-existing food formulations and the set of food processing conditions for the one or more pre-existing food formulations from the one or more sources. In addition, the primary functions of the system 106 include generating, using a machine learning model, a nutrient degradation profile for each nutrient corresponding to one or more ingredients associated with the one or more pre-existing food formulations, and determining, using the machine learning model, a set of degradation coefficients for each nutrient corresponding to the one or more ingredients associated with the one or more pre-existing food formulations, based on the generated nutrient degradation profile.

Also, the primary functions of the system 106 includes predicting, using the machine learning model, nutrient retention rates associated with the one or more pre-existing food formulations, based on at least the nutrient degradation profile, the set of food processing conditions, and historical nutrient retention data, and customizing, using the machine learning model, the one or more pre-existing food formulations based on the predicted nutrient retention rates to generate a customized food formulation.

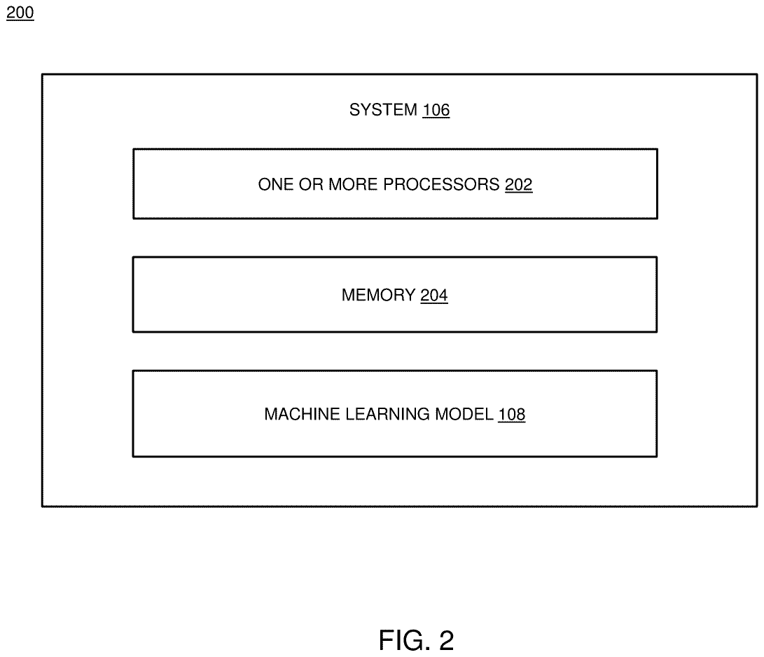

The system 106 interacts with the one or more sources 112 to retrieve the plurality of predefined regulatory guidelines. The one of more sources 112 includes at least one of regulatory databases, ingredient databases, cost datasets, environmental impact datasets, and behaviour studies. Further, the system 106 interacts with the one or more sources 112 to extract the set of data. The set of data includes at least a plurality of nutritional profiles, environmental impact metrics, cost related data, and palatability metrics, historical nutrient retention coefficients (further explained below in the description of FIG. 2).

Further, the system 106 interacts with the machine learning model 108. The machine-learning model 108 (hereinafter, “ML model 108”) is trained using pre-historic data and real-time data associated with the one or more input parameters to facilitate customization of the one or more pre-existing food formulations (explained below in the description of FIG. 2).

The ML model 108 may use several machine learning algorithms to process data and generate customized food formulations. These algorithms help the system 106 to balance multiple objectives like cost efficiency, sustainability, and nutritional adequacy.

In an embodiment, the ML model 108 uses supervised learning techniques, such as Regression Models, Neural Networks, and the like. In addition, the ML model 106 uses labelled data to learn relationships between input ingredients and output formulations. For instance, the pre-existing food formulations (with known costs, nutritional values, and user ratings) are fed into a neural network, which learns to generate a nutrient degradation profile for each nutrient corresponding to one or more ingredients associated with the one or more pre-existing food formulations.

In another embodiment, the ML model 108 may use unsupervised learning techniques, such as Clustering, Dimensionality Reduction, and the like. The system 106 uses unsupervised learning algorithms to identify hidden patterns in data. For example, clustering algorithms may identify groups of ingredients with similar nutritional profiles, enabling the system 106 to predict nutrient retention rates.

The system 106 interacts with various components of the interactive computing environment using a communication network 110. The communication network 110 acts as a central communication infrastructure of the interactive computing environment 100. The communication network 110 provides seamless connectivity between the user device 104, the system 106, the machine learning model 108 and the one or more data sources 112. The communication network 110 supports various communication protocols, including but not limited to TCP/IP, UDP, 2G, 3G, 4G, 5G, LTE, and other future protocols, enabling reliable data transfer between different components in the system 106. The communication network 110 facilitates real-time interaction, enabling generation of customized food formulations while maintaining cost efficiency, sustainability, nutritional adequacy, and palatability.

The user device 104 communicates with the system 106 through the communication network 110 to provide the one or more input parameters to the system 106. The communication network 110 ensures that the one or more input parameters, along with the plurality of pre-defined regulatory guidelines is transferred securely to the system 106.

Architecture of the system 106 supports flexible configurations, allowing different types of systems or devices to perform the functions described above. In some implementations, the system 106 may be any of a general-purpose device such as a computer or a special purpose device such as a client, a server, and the like. Any of these general or special purpose devices may include any suitable components such as a hardware processor (which can be a microprocessor, digital signal processor, a controller, etc.), memory, communication interfaces, display controllers, input devices, and the like. The system 106 may be deployed as a cloud-based system, an edge device, or an embedded device within the user device 104 itself. The communication network 110 ensures that these devices work seamlessly together, providing a scalable and efficient solution for the optimization of the food formulations.

The system 106 herein may correspond to a dedicated server, a cloud-based computing system, or an edge device embedded within the user device 104. In some implementations, the system 106 may be implemented as one server or can be distributed as any suitable number of servers. For example, multiple servers can be implemented in various locations to increase reliability, function of the application, and/or the speed at which the system 106 may communicate with the user device 104.

The number and arrangement of systems, devices, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems or a set of devices of the interactive computing environment 100 may perform one or more functions described as being performed by another set of systems or another set of devices of the interactive computing environment 100.

The system 106 is explained in detail in FIG. 2.

FIG. 2 illustrates an exemplary overview 200 of the system 106 for dynamically customizing the one or more pre-existing food formulations, in accordance with various embodiments of the present disclosure. The system 106 includes one or more components that interact with each other to facilitate dynamic customization of the one or more pre-existing food formulations. The one or more components includes but may not be limited to one or more processors 202, a memory 204, and the machine learning model 108. The memory 204 stores instructions that, when executed cause the one or more processors 202 to be operable to perform a set of steps (as described further).

The one or more processors 202 (hereinafter, the processor 202) is configured to receive the one or more input parameters from the user device 104. The one or more input parameters includes pet category, animal category, food habits, intended nutritional goals, geographical location, ingredient preferences, and ingredient exclusions. In an embodiment, the user device 104 includes but may not be limited to smart phone, laptop, computer, tablet, and palmtop. The user device 104 is associated with the user 102.

In an example, the user 102 accesses a web-based platform or mobile application on the user device 104 to upload or provide the one or more input parameters to the processor 202. Further, the processor 202 is configured to extract the one or more pre-existing food formulations and the set of food processing conditions for the one or more pre-existing food formulations from the one or more sources 112 based on the one or more input parameters. In an implementation, the processor 202 interacts with the one or more sources 112 to extract a plurality of predefined regulatory guidelines. The plurality of predefined regulatory guidelines are retrieved to ensure compliance with food industry standards, such as the AAFCO (Association of American Feed Control Officials) guidelines. For example, “The formulation must adhere to the nutritional guidelines for adult cat food as defined by AAFCO.

In an embodiment, the plurality of predefined regulatory guidelines are extracted based on the one or more input parameters from the one or more data sources 112. The plurality of pre-defined regulatory guidelines corresponds to established rules, standards, and best practices relevant to the food formulations for pets and animals. The plurality of predefined regulatory guidelines ensure that the resulting customized food formulations comply with regulatory frameworks in different jurisdictions.

The regulatory frameworks are related to various aspects of pet or animal food, such as nutritional composition, ingredient sourcing, sustainability standards, health and safety regulations, and environmental impact. The plurality of predefined regulatory guidelines is utilized by the ML model 108 to identify relevant regulatory guidelines based on the one or more input parameters. For example, if the user 102 sets a sustainability threshold, the ML model 108 prioritizes regulatory guidelines that address environmental impacts such as carbon footprint or water usage limits.

Further, the set of data is extracted from the one or more sources 112. The set of data is historical data associated with the one or more pre-existing food formulations. The set of data includes at least plurality of historical nutritional profiles, environmental impact metrics, cost-related data, palatability metrics, and historical nutrient retention coefficients. The set of data is stored in the memory 208 of the system 106. In general, the historical nutritional profiles refer to detailed information about nutritional composition of various ingredients present in the one or more pre-existing food formulations. The historical nutritional profiles include data on macro and micronutrients such as proteins, carbohydrates, fats, vitamins, and minerals, as well as other relevant aspects such as caloric density, digestibility, and biological value.

The memory 208 stores the historical nutritional profiles for each ingredient, allowing the ML model 108 to ensure the customized food formulation meets the specific nutritional requirements for target pet species (e.g., dog, cat) and animal species (e.g., chicken, cattle, sheep, goat).

The environmental impact metrics refer to data on environmental sustainability of ingredients used in the one or more pre-existing food formulations. The environmental impact metrics include data such as carbon footprint, water usage, energy consumption, and land use associated with producing and transporting ingredients.

The cost-related data herein refers to information on market cost of each ingredient, present in the one or more pre-existing food formulations. The cost-related data includes a price per unit of each ingredient (e.g., per kilogram or per ton) and may account for factors such as supply chain fluctuations or market trends that influence prices. In an example: if the cost of salmon rises due to seasonal factors or market demand, the system 106 stores updated cost data to reflect real-time pricing of ingredients. If a user prioritizes cost efficiency, the ML model 108 may customize the one or more pre-existing food formulations by selecting ingredients based on the lowest cost while maintaining nutritional adequacy.

The palatability metrics refer to data on acceptability and appeal of various ingredients to pets or animals. The palatability metrics include sensory attributes like taste, texture, and smell, which influence a pet's or animal's willingness to consume the food. The system 106 stores these metrics for each ingredient and uses them to ensure that the customized food formulation is palatable to pets or animals, encouraging consistent consumption and improving overall pet or animal health. In an example, for a dog food formulation, the system 106 may store the palatability metrics for ingredients like chicken, lamb, or turkey, with specific data on how dogs react to these flavors or textures.

The historical nutrient retention coefficients refer to scientifically derived values that indicate how much of a nutrient remains in an ingredient after undergoing a specific food processing method. These coefficients are derived based on past experimental data and industry studies that measure nutrient degradation during food processing methods (e.g., extrusion, baking, canning). The system 106 may store the historical nutrient retention coefficients for the ML model 108 to customize the one or more pre-existing food formulations that meet regulatory guidelines (AAFCO, etc.) while maintaining nutritional integrity despite losses associated with the set of pet or animal food processing types. The ML model 108 may trained based on the set of data extracted from the one or more sources 112 to perform customization of the one or more pre-existing food formulations.

The one or more sources 112 includes at least one of: regulatory databases, ingredient databases, cost datasets, environmental impact datasets, and behaviour studies. The regulatory databases ensure compliance with industry standards established by organizations such as the Association of American Feed Control Officials (AAFCO), the U.S. Food and Drug Administration (FDA), and the European Pet Food Industry Federation (EPDIAF). The ingredient databases include detailed profiles of raw materials, including nutrient values, allergen risks, and digestibility factors. The cost datasets provide real-time ingredient pricing, allowing for cost-effective generation of the customised food formulations.

The environmental impact datasets assess sustainability metrics such as greenhouse gas emissions and water consumption associated with ingredient sourcing. The behaviour studies contribute insights on palatability and consumption trends, ensuring that the pet food formulations or the animal feed align with pet or animal feeding preferences. In an embodiment, the one or more sources 112 may include government and regulatory body websites, such as those of the FDA, European Food Safety Authority (EFSA), or other relevant authorities. In addition, the one or more sources 112 include industry standards organizations like AAFCO or ISO (International Organization for Standardization). Further, the one or more sources 112 may include private databases maintained by regulatory or industry groups, which compile up-to-date standards and guidelines. Furthermore, the one or more sources 112 may include academic sources or peer-reviewed publications that detail new regulatory considerations and scientific advancements in food formulation.

Further, the one or more input parameters, the one or more pre-existing food formulations, the set of food processing conditions for the one or more pre-existing food formulations and the set of data are stored in the memory 204 of the system 106. In an implementation, the ML model 108 is trained based on at least the one or more input parameters, the one or more pre-existing food formulations, the set of food processing conditions for the one or more pre-existing food formulations and the set of data, to generate customized food formulation.

The processor 202 is configured to generate, using the machine learning model 108 (herein after, ML model 108) a nutrient degradation profile for each nutrient corresponding to the one or more ingredients associated with the one or more pre-existing food formulations. In an embodiment, the nutrient degradation profile is generated based on at least historical food processing data associated with the set of food processing conditions of the one or more pre-existing food formulations and scientific studies. The nutrient degradation profile for each nutrient corresponding to the one or more ingredients may be different for different food processing conditions of the set of food processing conditions. In another embodiment, the nutrient degradation profile is generated based on analysis of the one or more input parameters, the plurality of predefined regulatory guidelines, the one or more pre-existing food formulations, the set of food processing conditions and the set of data.

The nutrient degradation profile provides a detailed analysis of how different nutrients degrade under different food processing conditions of the set of food processing conditions. Different nutrients such as proteins, vitamins, and minerals are sensitive to processing factors like heat, pressure, moisture, and exposure to oxygen, their retention levels may vary significantly based on these conditions. The ML model 108 analyses historical data, scientific studies, and the plurality of predefined regulatory guidelines to predict how different processing methods affect stability and bioavailability of each nutrient.

For instance, consider a pre-existing pet food formulation containing Vitamin C and Omega-3 fatty acids, both of which are highly sensitive to heat. If this formulation undergoes an extrusion process at high temperatures, the ML model 108, based on historical processing data and scientific studies, may predict that 40% of Vitamin C and 30% of Omega-3 fatty acids degrade under these conditions. In contrast, if the formulation is processed using a cold-pressing method, the degradation may be significantly lower, say 15% for Vitamin C and 10% for Omega-3 fatty acids. The nutrient degradation profile generated for the nutrients may reflect the variations that facilitate adjustment of ingredient levels or modify processing conditions to compensate for the expected nutrient loss.

Further, the processor 202 is configured to determine a set of degradation coefficients for each nutrient corresponding to the one or more ingredients associated with the one or more pre-existing pet food formulations, using the ML model 108. The set of degradation coefficients are determined based on the generated nutrient degradation profile for each nutrient of the one or more ingredients and a selected food processing condition of the set of food processing types.

In an embodiment, the set of degradation coefficients serve as numerical values that quantify how much a specific nutrient degrades under a particular food processing condition of the set of food processing conditions. In an example, consider a pre-existing pet food formulation that contains vitamin C, omega-3 fatty acids, and protein. If the selected processing condition is extrusion at high temperatures (above 120° C.), the ML model 108 analyses the set of data (past or historical data) to determine how much of each nutrient is likely to degrade under these conditions. Suppose historical data indicates that vitamin C is highly heat-sensitive, degrading by 60% at 120° C. and 80% at 150° C., while omega-3 fatty acids degrade by 40% and protein by 10% under the same conditions. The ML model 108 then assigns degradation coefficients to each nutrient based on these observations.

Also, the processor 202 is configured to predict nutrient retention rates associated with the one or more pre-existing food formulations, based on at least: the nutrient degradation profile, the set of degradation coefficients, the set of food processing conditions, and historical nutrient retention data. The nutrient retention data includes data about an estimated time during processing when a nutrient remains stable and bioavailable before degradation starts. Further, the nutrient retention rates refer to a percentage of nutrients that remain in the pet food or the animal feed after undergoing the set of food processing conditions. Generally, nutrient retention rates indicate how much of each nutrient is preserved from an original formulation to a final product.

For predicting the nutrient retention rates, the processor 202 evaluates how different food processing conditions of the set of food processing conditions impact nutrient composition of the one or more pre-existing food formulations. The processor 202 evaluates this using the ML model 108 that considers the one or more input parameters, the plurality of predefined regulatory guidelines and the set of food processing conditions and the set of data such as nutrient retention coefficients, historical degradation trends, and the like.

Further, the processor 202 is configured to customize, using the machine learning model 108, the one or more pre-existing food formulations based on the predicted nutrient retention rates to generate the customized food formulation. Also, the processor 202 is configured to verify, using the machine learning model 108, the customized food formulations based on the one or more regulatory guidelines. To customize the one or more pre-existing food formulations, the processor 202 is configured to adjust, using the ML model 108, ingredient proportion of the one or more ingredients in the one or more pre-existing food formulations and modify a food processing condition associated with the one or more pre-existing food formulations. For example, if the regulatory standards require a minimum of 50 mg/kg of Vitamin C in a final pet food product, and the predicted nutrient retention rate is only 60%, the ML model 108 may adjust the initial ingredient proportion to ensure that the final product meets the required nutritional levels post-processing.

For example, consider a pre-existing pet food formulation designed for senior dogs that includes chicken meal, sweet potatoes, flaxseed, and vitamins. Suppose the ML model 108 predicts that, after high-temperature extrusion processing at 140° C., only 50% of the Vitamin C, 60% of Omega-3 fatty acids, and 90% of the protein may be retained. However, as per the user preference, the pet or animal requires a minimum of 80% Vitamin C retention. Based on the user preference, the ML model 108 automatically customizes the pre-existing food formulation in one or more ways. The one or more ways include adjusting ingredient proportions, modifying food processing conditions and the like. For adjusting ingredient proportions, the ML model 108 may increase initial concentration of vitamin C in the pre-existing food formulation. If 5 milligrams (mg) per serving was originally added, the ML model 108 may increase it to 8 mg, ensuring that even after a 50% degradation rate, the final product still meets the 4 mg minimum requirement.

Further, for modifying the food processing conditions, instead of using 140° C. extrusion, the processor 202 may change the food processing condition to a lower temperature (120° C.) than (the previous temperature during processing) with a slightly longer processing time to reduce vitamin C degradation. Alternatively, if freeze-drying results in better nutrient retention rates, the ML model 108 may switch to free-drying.

Once the pre-existing food formulation is customized, the processor 202 verifies its compliance with the plurality of predefined regulatory guidelines. For instance, if the regulatory requirement for protein in senior dog food is at least 18%, and the ML model 108 predicts that protein retention after processing may fall below this threshold, the processor 202 may increase the proportion of high-protein ingredients like chicken meal or fish meal. Additionally, the ML model 108 may check for compliance with ingredient sourcing, allergen control, and sustainability regulations. If a certain geographical region restricts the use of artificial preservatives, the processor 202 ensures the customized food formulation replaces them with natural alternatives like rosemary extract.

Further, the one or more pre-existing food formulations, the set of food processing conditions, and the set of data is stored in the memory 204 of the system 106 to generate the customized food formulation. In one implementation, the memory 204 may include a non-transitory memory that stores software instructions, algorithms, and pre-trained models (machine-learning model 108) used by the system 106. In an embodiment, the non-transitory memory stores essential data, including the one or more input parameters, user preferences, ingredient databases, nutritional information, market trends, and other relevant datasets. The non-transitory memory allows the system 106 to extract historical data, making it possible to generate customized food formulations.

The non-transitory memory may include one or more computer-readable storage mediums. The computer-readable storage mediums may be tangible and non-transitory. For instance, the non-transitory memory may include high-speed random-access memory and may include non-volatile memory, such as one or more magnetic disk storage devices, flash memory devices, or other non-volatile solid-state memory devices.

In some examples, a non-transitory computer-readable storage medium of the non-transitory memory can be used to store instructions (e.g., for performing aspects of process 300, described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of process 300, described below) can be stored on a non-transitory computer-readable storage medium (not shown) of the system 106. In the context of this document, a “non-transitory computer-readable storage medium” can be any medium that can contain or store the program for use by or in connection with the instruction execution system, apparatus, or device.

The non-transitory memory stores training data used for training the ML model 108, ensuring the system 106 can continuously learn and improve based on past inputs and feedback received from the user 102. The ML model 108 is trained using the one or more input parameters, the set of food processing conditions, and the set of data that includes pre-historic data associated with the one or more pre-existing food formulations. The pre-historic data is stored in the memory 204 and the real time data is received from at least one of: the user device 102 and the one or more regulatory databases. The memory 204 is periodically updated based on at least a scientific research updates, regulatory updates, change in existing user preferences, and market pricing trends to update the ML model 108.

The scientific research updates include new studies that may reveal improved nutrient formulations, enhanced ingredient bioavailability, or additional health benefits of certain compounds. For instance, if recent scientific research demonstrates that a specific probiotic strain significantly enhances gut health in dogs, the ML model 108 analyses this and customizes an existing food formulation by incorporating the probiotic into the existing formulation for digestive support. Further, the regulatory updates play an important role in customization of the one or more pre-existing food formulations. Organizations such as AAFCO (Association of American Feed Control Officials) and EPDIAF (European Pet Food Industry Federation) frequently revise their guidelines, introducing new nutrient requirements or restricting certain ingredients.

If AAFCO updates its standards to mandate higher Omega-3 levels in puppy or animal food, the ML model 108 promptly identifies this change and customizes the pre-existing food formulation by increasing DHA levels by incorporating fish oil or algae-based sources into the affected formulations. Further, if there is change in existing user preferences, for example, increasing demand for plant-based pet food, instead of animal-driven pet food, the ML model 108 customizes the pre-existing food formulation by replacing animal-derived proteins, such as chicken meal, with plant-based alternatives

In an embodiment, the ML model 108 may be a part of the processor 202 of the system 106. In another embodiment, The ML model 108 is integrated in a separate entity present outside the system 106 but associated with the system 106 through the communication network 110 (as shown in FIG. 1). The machine learning model 108 includes at least one of one or more regression models, and neural networks.

In general, regression model is a type of supervised machine learning algorithm used to predict continuous numerical values based on input data. In an embodiment of the present disclosure, the one or more regression models facilitate generating the nutrient degradation profile, determining the set of degradation coefficients and predicting the nutrient retention rates. Also, the ML model 108 facilitates in quantifying relationship between various food processing conditions (e.g., temperature, pressure, and cooking duration) and the nutrient retention rates to customize the one or more pre-existing food formulations.

For example, a multiple linear regression model may analyse historical data and predict how temperature, cooking time, and moisture levels impact Vitamin B12 retention. Suppose historical data shows that a temperature increases from 100° C. to 150° C. leads to a 30% additional loss of Vitamin B12. The regression model may learn this pattern to predict how much B12 would remain at different processing temperatures, allowing for customizations in the one or more pre-existing food formulations. Other types of regression models, such as logistic regression or polynomial regression, may be used to model more complex, non-linear relationships between the set of food processing conditions and nutrient stability.

Further, the ML model 108 may be a deep neural network (DNN) that processes large amounts of multi-variable data, such as the one or more input parameters, the set of food processing conditions, the set of data (historical data), the generated nutrient degradation profile, to predict the nutrient retention rates for customization of the one or more pre-existing food formulations. In an example, the ML model 108 may include a convolutional neural network (CNN) or recurrent neural network (RNN) for analysing time-series data, such as trends in ingredient quality over time or seasonal variations in raw material nutrient content and the like.

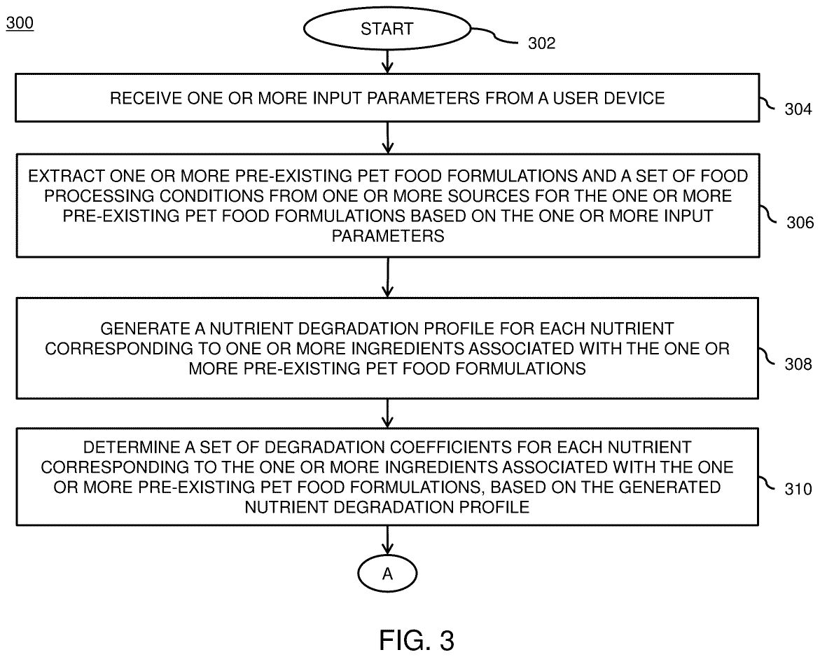

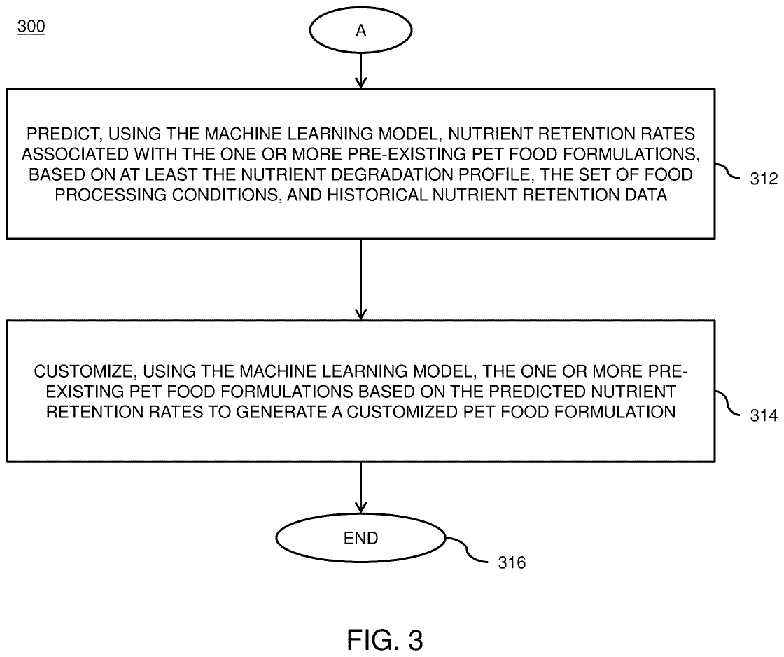

FIG. 3 illustrates a flowchart 300 of a method for generating the food formulations, in accordance with various embodiments of the present disclosure. It may be noted that the description of the flowchart 300 refers to FIG. 1 and FIG. 2. The working and functioning may be read from the description of FIG. 1 and FIG. 2.

The flowchart 300 initiates at step 302. At step 304, the method includes receiving the one or more input parameters from the user device 104. The one or more input parameters include pet category, food habits, animal category, intended nutritional goals, geographical location, ingredient preferences, and ingredient exclusions.

At step 306, the method includes extracting the one or more pre-existing food formulations and a set of food processing conditions from the one or more sources for the one or more pre-existing food formulations based on the one or more user-defined parameters from the one or more data sources 112. The one or more sources includes at least one of: regulatory databases, historical datasets, ingredient databases, cost datasets, environmental impact datasets, and behaviour studies.

At step 308, the method includes generating the nutrient degradation profile for each nutrient corresponding to the one or more ingredients associated with the one or more pre-existing food formulations, using the machine learning model 108 (as explained in FIG. 2).

At step 310, the method includes determining, using the machine learning model, the set of degradation coefficients for each nutrient corresponding to the one or more ingredients associated with the one or more pre-existing food formulations, based on the generated nutrient degradation profile. In an embodiment, the set of degradation coefficients serve as numerical values that quantify how much a specific nutrient degrades under a particular food processing condition of the set of food processing conditions.

In an example, consider a pre-existing pet food formulation that contains vitamin C, omega-3 fatty acids, and protein. If the selected processing condition is extrusion at high temperatures (above 120° C.), the ML model 108 analyses the set of data (past or historical data) to determine how much of each nutrient is likely to degrade under these conditions. Suppose historical data indicates that vitamin C is highly heat-sensitive, degrading by 60% at 120° C. and 80% at 150° C., while omega-3 fatty acids degrade by 40% and protein by 10% under the same conditions. The ML model 108 then assigns degradation coefficients to each nutrient based on these observations.

At step 312, the method includes predicting, using the machine learning model, nutrient retention rates associated with the one or more pre-existing food formulations, based on at least the nutrient degradation profile, the set of food processing conditions, and historical nutrient retention data (as explained in FIG. 2).

At step 314, the method includes customizing, using the machine learning model 108, the one or more pre-existing food formulations based on the predicted nutrient retention rates to generate the customized food formulation (as explained in FIG. 2).

The flowchart 300 ends at step 316. It may be noted that the flowchart 300 includes the above stated process steps. However, there may be more number of steps in the flowchart 300.

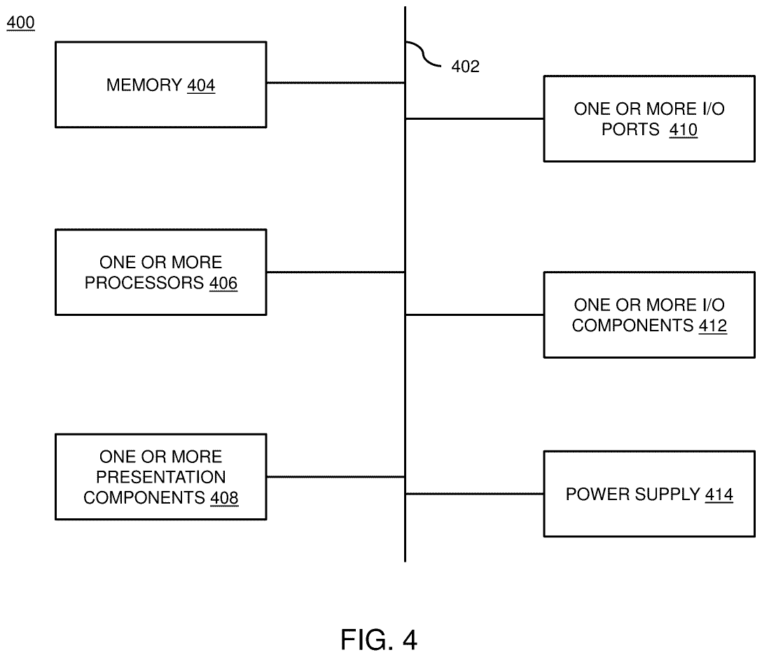

FIG. 4 illustrates an exemplary block diagram of a computing device 400, in accordance with various embodiments of the present disclosure. The block diagram illustrates a general architecture for the computing device 400 that may be employed to implement various elements of the systems and methods described and illustrated herein. The computing device 400 can be used to implement the system 106, the user device 104, the ML model 108, the database 208, etc. The computing device 400 is a non-transitory computer-readable storage medium. For example, the non-transitory computer-readable storage medium can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. In an implementation, the computing device 400 is identical to the system 106 of FIG. 1. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414.

The bus 402 represents what may be one or more buses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 4 is merely illustrative of the exemplary computing device 400 that can be used in connection with one or more embodiments of the present disclosure. Distinction is not made between such categories as “workstation,” “server,” “laptop,” “hand-held device,” etc., as all are contemplated within the scope of FIG. 4 and reference to “device.”

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should be included within the scope of computer-readable media.

The memory 404 includes computer-storage media in the form of volatile and/or non-volatile memory. The memory 404 may be removable, non-removable, or a combination thereof. Exemplary hardware devices include solid-state memory, hard drives, optical-disc drives, etc. The computing device 400 includes the one or more processors 406 that read data from various entities such as the memory 404 or the I/O components 412. The one or more presentation components 408 present data indications to a user or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

The computing device 400 can be of varying types including a workstation, server (the system 106), computing cluster, blade server, server farm, or any other data processing system or computing device. Due to the ever-changing nature of computers and networks, the description of the computing device 400 depicted in FIG. 4 is intended only as a specific example for purposes of illustrating some implementations. Many other configurations of the computing device 400 are possible having more or fewer components than the computing device depicted in FIG. 4.

In an aspect, the present disclosure relates to a non-transitory computer-readable medium storing one or more instructions for dynamically customizing the one or more pre-existing food formulations. The one or more instructions which, when executed by a processor (similar to the processing unit 210), causes the processor to receive the one or more input parameters from the user device 104. The one or more instructions which, when executed, causes the processor to extract one or more pre-existing food formulations and a set of food processing conditions for the one or more pre-existing food formulations from the one or more sources 112 based on the one or more input parameters. In addition, the one or more instructions which, when executed, causes the processor to generate, using the machine learning model, the nutrient degradation profile for each nutrient corresponding to one or more ingredients associated with the one or more pre-existing food formulations. Further, the one or more instructions which, when executed, causes the processor to determine, using the machine learning model 108, a set of degradation coefficients for each nutrient corresponding to the one or more ingredients associated with the one or more pre-existing food formulations, based on the generated nutrient degradation profile.

Also, the one or more instructions which, when executed, causes the processor to predict, using the machine learning model, nutrient retention rates associated with the one or more pre-existing food formulations, based on at least the nutrient degradation profile, the set of food processing conditions, and historical nutrient retention data. The one or more instructions which, when executed, causes the processor to customizing, using the machine learning model, the one or more pre-existing food formulations based on the predicted nutrient retention rates to generate a customized food formulation.

The present disclosure provides various advantages by leveraging machine learning for dynamic customization of the pre-existing food formulations, ensuring enhanced nutritional accuracy through precise prediction of nutrient degradation profiles and retention rates. The system allows for personalized formulations based on pet/animal category, location, ingredient availability, cost, and sustainability, adapting recipes dynamically to individual needs. By optimizing food processing conditions, it minimizes nutrient loss while improving food quality and efficacy. The system enhances cost efficiency by reducing waste and optimizing ingredient selection, leading to cost-effective formulations. Additionally, it ensures regulatory compliance by verifying formulations against industry standards like AAFCO and FEDIAF. Incorporating sustainability parameters, it supports eco-friendly ingredient substitutions and reduces energy consumption, making pet food or animal feed production more sustainable. The machine learning model continuously improves with historical and real-time data, enhancing palatability, shelf life, and health benefits over time. This AI-driven approach provides pet food and animal feed manufacturers with a competitive edge, enabling rapid adaptation to market trends and consumer demands, ultimately delivering science-backed, high-quality food formulations.

The foregoing descriptions of specific embodiments of the present technology have been presented for the purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the disclosure have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A method for dynamically customizing food formulations, the method comprising:
receiving one or more input parameters from a user device;
extracting one or more pre-existing food formulations and a set of food processing conditions for the one or more pre-existing food formulations from one or more sources based on the one or more input parameters;
generating, using a machine learning model, a nutrient degradation profile for each nutrient corresponding to one or more ingredients associated with the one or more pre-existing food formulations;
determining, using the machine learning model, a set of degradation coefficients for each nutrient corresponding to the one or more ingredients associated with the one or more pre-existing food formulations based on the generated nutrient degradation profile;
predicting, using the machine learning model, nutrient retention rates associated with the one or more pre-existing food formulations based on at least the nutrient degradation profile, the set of food processing conditions, and historical nutrient retention data; and
customizing, using the machine learning model, the one or more pre-existing food formulations based on the predicted nutrient retention rates to generate a customized food formulation.

2. The method as claimed in claim 1, wherein the food formulations comprise at least a pet food formulation and an animal feed.

3. The method as claimed in claim 1, further comprising verifying, using the machine learning model, the customized food formulation based on one or more regulatory guidelines.

4. The method as claimed in claim 1, wherein the one or more input parameters comprises: pet category, animal category, geographical location, ingredient data, cost-related data, and environmental sustainability parameters.

5. The method as claimed in claim 1, wherein the nutrient degradation profile is generated based on at least historical food processing data associated with the set of food processing conditions of the one or more pre-existing food formulations and scientific studies.

6. The method as claimed in claim 1, wherein the machine learning model comprises at least one of one or more regression models, and neural networks.

7. The method as claimed in claim 1, wherein the customization of the one or more pre-existing food formulations comprises at least one of:
adjusting ingredient proportion of the one or more ingredients in the one or more pre-existing food formulations; and
modifying a food processing condition associated with the one or more pre-existing food formulations.

8. A system for dynamically customizing food formulations, the system comprising:
one or more processors; and
a memory storing instructions that, when executed, cause the one or more processors to be operable to:
receive one or more input parameters from a user device;
extract one or more pre-existing food formulations and a set of food processing conditions for the one or more pre-existing food formulations from one or more sources based on the one or more input parameters;
generate, using a machine learning model, a nutrient degradation profile for each nutrient corresponding to one or more ingredients associated with the one or more pre-existing food formulations ;
determine, using the machine learning model, a set of degradation coefficients for each nutrient corresponding to the one or more ingredients associated with the one or more pre-existing food formulations, based on the generated nutrient degradation profile;
predict, using the machine learning model, nutrient retention rates associated with the one or more pre-existing food formulations, based on at least: the nutrient degradation profile, the set of degradation coefficients, the set of food processing conditions, and historical nutrient retention data; and
customize, using the machine learning model, the one or more pre-existing food formulations based on the predicted nutrient retention rates to generate a customized food formulation.

9. The system as claimed in claim 8, wherein the food formulations comprise at least a pet food formulation and an animal feed.

10. The system as claimed in claim 8, wherein the one or more processors are configured to verify, using the machine learning model, the customized food formulation based on one or more regulatory guidelines.

11. The system as claimed in claim 8, wherein the one or more input parameters comprise pet category, animal category, geographical location, ingredient data, cost-related data, and environmental sustainability parameters.

12. The system as claimed in claim 8, wherein the nutrient degradation profile is generated based on at least historical food processing data associated with the set of food processing conditions of the one or more pre-existing food formulations and scientific studies.

13. The system as claimed in claim 8, wherein the machine learning model comprises at least one of one or more regression models, and neural networks.

14. The system as claimed in claim 8, wherein the one or more processors are configured to customize the one or more pre-existing food formulations by:
adjusting, using the machine learning model, ingredient proportion of the one or more ingredients in the one or more pre-existing food formulations; and
modifying, using the machine learning model, a food processing condition associated with the one or more pre-existing food formulations.

15. A non-transitory computer-readable storage medium storing instructions that, when executed, cause the one or more processors to perform operations, the operations comprising:
receiving one or more input parameters from a user device;
extracting one or more pre-existing food formulations and a set of food processing conditions for the one or more pre-existing food formulations based on the one or more parameters;
generating, using a machine learning model, a nutrient degradation profile for each nutrient corresponding to one or more ingredients associated with the one or more pre-existing food formulations;
determining, using the machine learning model, a set of degradation coefficients for each nutrient corresponding to the one or more ingredients associated with the one or more pre-existing food formulation, based on the generated nutrient degradation profile;
predicting, using the machine learning model, nutrient retention rates associated with the one or more pre-existing food formulations, based on at least: the nutrient degradation profile, the set of food processing conditions, and historical nutrient retention data; and
customizing, using the machine learning model, the one or more pre-existing food formulations based on the predicted nutrient retention rates to generate a customized food formulation.

16. The non-transitory computer-readable storage medium as claimed in claim 15, wherein the food formulations comprise at least a pet food formulation and an animal feed.

17. The non-transitory computer-readable storage medium as claimed in claim 15, wherein the one or more processors are configured to verify, using the machine learning model, the customized food formulation based on one or more regulatory guidelines.

18. The non-transitory computer-readable storage medium as claimed in claim 15, wherein the one or more input parameters comprise pet category, animal category, geographical location, ingredient data, cost-related data, and environmental sustainability parameters.

19. The non-transitory computer-readable storage medium as claimed in claim 15, wherein the nutrient degradation profiles are generated based on at least historical food processing data associated with the set of food processing conditions of the one or more pre-existing food formulations and scientific studies.

20. The non-transitory computer-readable storage medium as claimed in claim 15, wherein the machine learning model comprises at least one of one or more regression models, and neural networks.
